(19) United States
(12) Patent Application Publication
(10) Pub. No.: US 2022/0377747 A1
(43) Pub. Date: Nov. 24, 2022

(54) METHOD, DEVICE AND COMPUTER READABLE MEDIUM FOR CHANNEL QUALITY MEASUREMENT

(71) Applicant: NEC CORPORATION, Tokyo (JP)

(72) Inventors: Fang YUAN, Beijing (CN); Gang WANG, Beijing (CN)

(73) Assignee: NEC CORPORATION, Tokyo (JP)

(21) Appl. No.: 17/763,477

(22) PCT Filed: Sep. 25, 2019
(86) PCT No.: PCT/CN2019/107924

§ 371 Date: Mar. 24, 2022

(51) Int. Cl. H04W 72/08; H04W 72/04

(52) U.S. Cl. CPC H04W 72/082; H04W 72/0446; H04W 72/046; H04W 72/0406

(57) ABSTRACT

Embodiments of the present disclosure relate to methods, devices and computer readable media for channel quality measurement. In example embodiments, a method implemented in a network device includes determining first configuration information comprising a first slot offset value associated with a first resource set for channel measurements and a second slot offset value associated with a second resource set for interference measurements; and transmitting the first configuration information to a terminal device. A method implemented in a terminal device includes receiving the first configuration information; and in response to receiving, from the network device, first control information indicating that the first configuration information is used, performing the channel measurements and the interference measurements based on the first and second slot offset values. In this way, more flexible interference measurement based beam reporting is enabled.

### TECHNICAL FIELD

Embodiments of the present disclosure generally relate to the field of telecommunication, and in particular, to methods, devices and computer readable media for channel quality measurement.

### BACKGROUND

New radio (NR) is a set of enhancements to the Long Term Evolution (LTE) mobile standard promulgated by Third Generation Partnership Project (3GPP). It is designed to better support beamforming, multiple-input multiple-output (MIMO) antenna technology, and carrier aggregation.

In NR, a terminal device (e.g. user equipment, UE) and a network device (e.g. gNodeB) can communicate via a plurality of beams, which is called multi-beam operation. To enhance the multi-beam operation, it has been agreed that layer 1-signal to interference-and-noise ratio (L1-SINR) measurement should be supported in NR. Therefore, there is a need to specify the measurement and reporting of L1-SINR, particularly for beam management purpose.

### SUMMARY

In general, embodiments of the present disclosure provide methods, devices and computer storage media for SNR measurement.

In a first aspect, there is provided a method of communication. The method comprises: receiving, at a terminal device and from a network device, first configuration information comprising a first slot offset value associated with a first resource set for channel measurements and a second slot offset value associated with a second resource set for interference measurements; and in response to receiving, from the network device, first control information indicating that the first configuration information is used, performing the channel measurements and the interference measurements based on the first and second slot offset values.

In a second aspect, there is provided a method of communication. The method comprises: receiving, at a terminal device and from a network device, second configuration information comprising fourth slot offset values associated with resources in a fourth resource set for channel measurements and fifth slot offset values associated with resources in a fifth resource set for interference measurements; and in response to receiving, from the network device, second control information indicating that the second configuration information is used, performing the channel measurements and the interference measurements based on the fourth and fifth slot offset values.

In a third aspect, there is provided a method of communication. The method comprises: receiving, at a terminal device and from a network device, third configuration information comprising a seventh slot offset value associated with a seventh resource set for channel measurements and interference measurements; and in response to receiving, from the network device, third control information indicating that the third configuration information is used, performing the channel measurements and the interference measurements based on the seventh slot offset value.

In a fourth aspect, there is provided a method of communication. The method comprises: receiving, at a terminal device and from a network device, fourth configuration information comprising eighth slot offset values associated with resources in an eighth resource set for channel measurements and interference measurements; and in response to receiving, from the network device, fourth control information indicating that the fourth configuration information is used, performing the channel measurements and the interference measurements based on the eighth slot offset values.

In a fifth aspect, there is provided a method of communication. The method comprises: determining, at a network device, first configuration information comprising a first slot offset value associated with a first resource set for channel measurements and a second slot offset value associated with a second resource set for interference measurements; and transmitting the first configuration information to a terminal device for performance of the channel measurements and the interference measurements based on the first and second slot offset values in response to receiving, from the network device, first control information indicating that the first configuration information is used.

In a sixth aspect, there is provided a method of communication. The method comprises: determining, at a network device, second configuration information comprising fourth slot offset values associated with resources in a fourth resource set for channel measurements and fifth slot offset values associated with resources in a fifth resource set for interference measurements; and transmitting the second configuration information to a terminal device for performance of the channel measurements and the interference measurements based on the fourth and fifth slot offset values in response to receiving, from the network device, second control information indicating that the second configuration information is used.

In a seventh aspect, there is provided a method of communication. The method comprises: determining, at a network device, third configuration information comprising a seventh slot offset value associated with a seventh resource set for channel measurements and interference measurements; and transmitting the third configuration information to a termination device for performance of the channel measurements and the interference measurements based on the seventh slot offset value in response to receiving, from the network device, third control information indicating that the third configuration information is used.

In an eighth aspect, there is provided a method of communication. The method comprises: determining, at a network device, fourth configuration information comprising eighth slot offset values associated with resources in an eighth resource set for channel measurements and interference measurements; and transmitting the fourth configuration information to a terminal device for performance of the channel measurements and the interference measurements based on the eighth slot offset values in response to receiving, from the network device, fourth control information indicating that the fourth configuration information is used.

In a ninth aspect, there is provided a terminal device. The terminal device comprises a processor and a memory coupled to the processor. The memory stores instructions that when executed by the processor, cause the terminal device to perform the method according to any of the first to fourth aspects of the present disclosure.

In a tenth aspect, there is provided a network device. The network device comprises a processor and a memory coupled to the processor. The memory stores instructions that when executed by the processor, cause the network device to perform the method according to any of the fifth to eighth aspects of the present disclosure.

In an eleventh aspect, there is provided a computer readable medium having instructions stored thereon. The instructions, when executed on at least one processor, cause the at least one processor to perform the method according to any of the first to fourth aspects of the present disclosure.

In a twelfth aspect, there is provided a computer readable medium having instructions stored thereon. The instructions, when executed on at least one processor, cause the at least one processor to perform the method according to any of the fifth to eighth aspects of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 is a schematic diagram of a communication environment in which embodiments of the present disclosure can be implemented;

FIG. 2 is a schematic diagram illustrating a process of channel and interference measurements for beam reporting;

FIG. 3 shows a flowchart of an example method in accordance with some embodiments of the present disclosure;

FIG. 4 shows a schematic diagram illustrating resources configured for CM and IM associated with beams according to some embodiments of the present disclosure;

FIG. 5 shows a flowchart of an example method in accordance with some embodiments of the present disclosure;

FIG. 6 shows a schematic diagram illustrating resources configured for CM and IM associated with beams according to some embodiments of the present disclosure;

FIG. 7 shows a flowchart of an example method in accordance with some embodiments of the present disclosure;

FIG. 8 shows a schematic diagram illustrating resources configured for CM and IM associated with beams according to some embodiments of the present disclosure;

FIG. 9 shows a schematic diagram illustrating a correspondence relationship between CMR/IMRs and CSI-RSs according to some embodiments of the present disclosure;

FIG. 10 shows a flowchart of an example method in accordance with some embodiments of the present disclosure;

FIG. 11 shows a schematic diagram illustrating resources configured for CM and IM associated with beams according to some embodiments of the present disclosure;

FIG. 12 shows a flowchart of an example method in accordance with some embodiments of the present disclosure;

FIG. 13 shows a flowchart of an example method in accordance with some embodiments of the present disclosure;

FIG. 14 shows a flowchart of an example method in accordance with some embodiments of the present disclosure;

FIG. 15 shows a flowchart of an example method in accordance with some embodiments of the present disclosure; and

FIG. 16 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. The term “terminal device” can be used interchangeably with a UE, a mobile station, a subscriber station, a mobile terminal, a user terminal or a wireless device. In addition, the term “network device” refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Transmission Reception Point (TRP), a Remote Radio Unit (RRU), a radio head (RH), a remote radio head (RRH), a low power node such as a femto node, a pico node, and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, a first information may be transmitted to the terminal device from the first network device and a second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As mentioned above, multi-beam operation is supported in NR and thus beam management in NR is also specified. For example, technical specification (TS) 38.214 has specified the following: If the UE is configured with a CSI-ReportConfig with reportQuantity set to “cri-RSRP”, or “none” and if the CSI-ResourceConfig for channel measurement (higher layer parameter resourcesForChannelMeasurement) contains a NZP-CSI-RS-ResourceSet that is configured with the higher layer parameter repetition and without the higher layer parameter trs-Info, the UE can only be configured with the same number (1 or 2) of ports with the higher layer parameter nrofPorts for all CSI-RS resources within the set.

Conventionally, reference signal received power (RSRP) is measured to determine a channel quality. In order to enhance the multi-beam operation, L1-SINR measurement will be supported in NR. For example, secondary synchronization SINR (SS-SINR) is defined as the linear average over the power contribution (in [W]) of the resource elements carrying secondary synchronization signals divided by the linear average of the noise and interference power contribution (in [W]) over the resource elements carrying secondary synchronization signals within the same frequency bandwidth.

As another example, channel state information SINR (CSI-SINR) is defined as the linear average over the power contribution (in [W]) of the resource elements carrying CSI reference signals divided by the linear average of the noise and interference power contribution (in [W]) over the resource elements carrying CSI reference signals reference signals within the same frequency bandwidth.

To determine the SINR, channel measurement (CM, which may also be referred to as signal measurement) and interference measurement (IM, which may also be referred to as interference or noise measurement) need to be perform at the terminal device, e.g. at UE. CSI resource and synchronization signal/physical broadcast channel block (SSB) resource may be configured for SINR measurement. For example, TS 38.214 has specified that the UE may assume that the non-zero power CSI reference signal (NZP CSI-RS) resource(s) for channel measurement and the CSI-IM resource(s) for interference measurement configured for one CSI reporting are resource-wisely quasi-co-located with respect to ‘QCL-TypeD’ (When two different signals share the same QCL type, they share the same indicated properties. QCL-TypeD means a spatial receiver (RX), for example, a beam). When NZP CSI-RS resource(s) is used for interference measurement, the UE may assume that the NZP CSI-RS resource for channel measurement and the CSI-RS resource and/or NZP CSI-RS resource(s) for interference measurement configured for one CSI reporting are quasi-co-located with respect to ‘QCL-TypeD’.

Further, if interference measurement is performed on CSI-IM, each CSI-RS resource for channel measurement is resource-wise associated with a CSI-IM resource by the ordering of the CSI-RS resource and CSI-IM resource in the corresponding resource sets. The number of CSI-RS resources for channel measurement equals to the number of CSI-IM resources.

Recently, it has been agreed that for L1-SINR based beam report, in a CSI-reportConfig, if resources for IM (also called interference measurement resource (MR) herein) are configured to be based on ZP-IMR only, resources for CM (also called channel measurement resource (CMR) herein) and IMR are 1-to-1 mapped from signaling perspective. However, For L1-SINR based beam report, in a CSI-reportConfig, if IMR is configured to be based on NZP-IMR only, the resource configuration schemes have not been agreed. At least one of the following may be adopted: CMR and IMR are 1-to-1 mapped; 1 CMR can be mapped to 1 or more than 1 IMRs; 1 IMR can be mapped to 1 or more than 1 CMRs; and More than 1 IMRs can be mapped to more than 1 CMRs.

As to an aperiodic CSI reporting or aperiodic CSI-RS, TS 38.214 has specified that when aperiodic CSI-RS is used with aperiodic reporting, the CSI-RS offset is configured per resource set by the higher layer parameter aperiodic TriggeringOffset. The CSI-RS triggering offset has the values of {0, 1, 2, 3, 4, 16, 24} slots. If all the associated trigger states do not have the higher layer parameter qcl-Type set to ‘QCL-TypeD’ in the corresponding TCI states, the CSI-RS triggering offset is fixed to zero. The aperiodic triggering offset of the CSI-IM follows offset of the associated NZP CSI-RS for channel measurement. Further, if interference measurement is performed on aperiodic NZP CSI-RS, a UE is not expected to be configured with a different aperiodic triggering offset of the NZP CSI-RS for interference measurement from the associated NZP CSI-RS for channel measurement.

It can be seen that the slot offset for IMR is the same as the slot offset for CMR in current CSI reporting. In this case, as the number of beams used in NR is large, in some situations, one slot may be insufficient to accommodate all the beams. It is inconvenient for SINR measurement and may cause an incorrect SINR measurement.

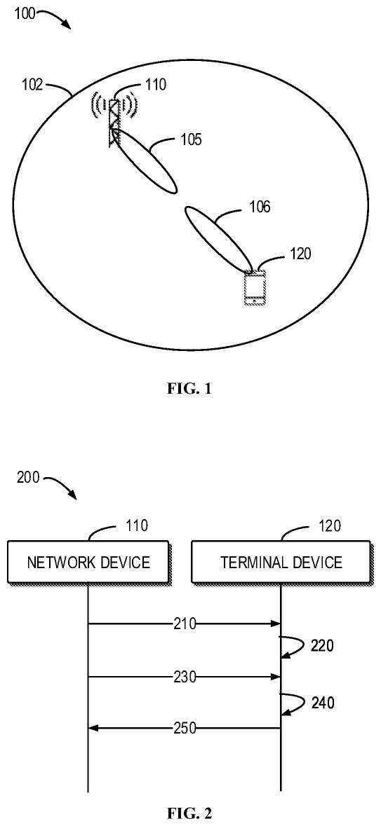

According to embodiments of the present disclosure, there is proposed an improved solution for SINR measurement. New offset configuration for SINR based beam reporting is proposed. For aperiodic (AP) or periodic/semi-persistent (P/SP) transmission of reference signals, ZP or NZP-based IMR, one or more configured resource set, and so on, separate offset configurations for CMR and IMR are provided correspondingly. In this way, offset for IMR is provided separately from that for CMR, and more flexible interference measurement for SINR based beam reporting is enabled. Principle and implementations of the present disclosure will be described in detail below with reference to FIGS. 1-16.

FIG. 1 shows an example communication network 100 in which embodiments of the present disclosure can be implemented. The network 100 includes a network device 110 and a terminal device 120 served by the network device 110. The serving area of the network device 110 is called as a cell 102. It is to be understood that the number of network devices and terminal devices is only for the purpose of illustration without suggesting any limitations. The network 100 may include any suitable number of network devices and terminal devices adapted for implementing embodiments of the present disclosure. Although not shown, it is to be understood that one or more terminal devices may be located in the cell 102 and served by the network device 110.

In the communication network 100, the network device 110 can communicate data and control information to the terminal device 120 and the terminal device 120 can also communication data and control information to the network device 110. A link from the network device 110 to the terminal device 120 is referred to as a downlink (DL) or a forward link, while a link from the terminal device 120 to the network device 110 is referred to as an uplink (UL) or a reverse link.

Depending on the communication technologies, the network 100 may be a Code Division Multiple Access (CDMA) network, a Time Division Multiple Address (TDMA) network, a Frequency Division Multiple Access (FDMA) network, an Orthogonal Frequency-Division Multiple Access (OFDMA) network, a Single Carrier-Frequency Division Multiple Access (SC-FDMA) network or any others. Communications discussed in the network 100 may use conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols. The techniques described herein may be used for the wireless networks and radio technologies mentioned above as well as other wireless networks and radio technologies. For clarity, certain aspects of the techniques are described below for LTE, and LTE terminology is used in much of the description below.

In embodiments, the network device 110 is configured to implement beamforming technique and transmit signals to the terminal device 120 in a plurality of beams, one of which is shown as a beam 105. The terminal device 120 is configured to receive the signals transmitted by the network device 110 in a plurality of beams, one of which is shown as a beam 106.

FIG. 2 is a schematic diagram illustrating a process 200 of channel and interference measurements for beam reporting. As shown in FIG. 2, the network device 110 transmits 210 configurations of CMRs and IMRs to the terminal device 120. For example, the configurations of the CMRs and IMRs may be signaled to the terminal device 120 by a radio resource control (RRC) signaling, a media access control (MAC) control element (CE) or downlink control information (DCI). In embodiments of the present disclosure, the configurations of CMRs and IMRs may include one or more slot offset values of CMRs and that of IMRs. The terminal device 120 stores 220 the configurations of CMR and IMRs for subsequent channel and interference measurements.

The network device 110 transmits 230 control information to enable the terminal device 120 to perform channel and interference measurements associated with beams. For example, the control information may be in a form of DCI. It should be note that the control information may be in any other suitable forms and is not limited here. Upon receiving the control information, the terminal device 120 performs 240 channel and interference measurements based on the stored configurations of CMRs and IMRs.

During the channel and interference measurements, the terminal device 120 may receive (not shown in FIG. 2) reference signals such as CSI-RSs from the network device 110 on the CMRs and IMRs respectively, determine channel quality (e.g. SINR) associated with each of the beams based on the received reference signals, and select one or more beams with optimal channel quality among the beams. Then the terminal device 120 transmits 250 a beam report including an indication of the selected beam(s) to the network device 110. The indication may be an indication of the RS(s) corresponding to the selected beam(s). For example, the indication may be CSI-resource indicator (CRI).

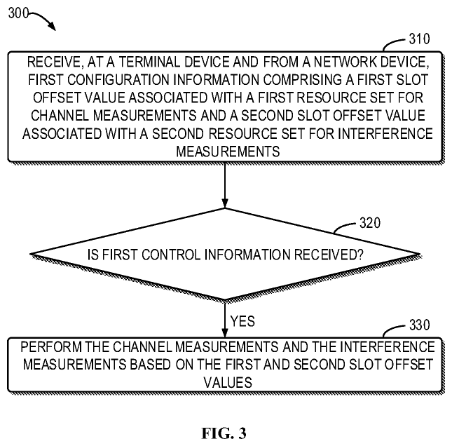

Implementations of the present disclosure will be described in detail below with reference to FIGS. 3-16. FIG. 3 illustrates a flowchart of an example method 300 in accordance with some embodiments of the present disclosure. The method 300 can be implemented at the terminal device 120 shown in FIG. 1. It is to be understood that the method 300 may include additional blocks not shown and/or may omit some blocks as shown, and the scope of the present disclosure is not limited in this regard. For the purpose of discussion, the method 300 will be described with reference to FIG. 1.

At block 310, the terminal device 120 receives, from the network device 110, first configuration information comprising a first slot offset value associated with a first resource set for channel measurements and a second slot offset value associated with a second resource set for interference measurements. This will be detailed with reference to Embodiments 1 and 2.

### Embodiment 1

In this embodiment, reference signals with an explicit transmit power are aperiodically transmitted from the network device 110 on the first resource set and reference signals without an explicit transmit power are transmitted on the second resource set. This is also called as aperiodic zero power interference measurement (AP ZP-IMR) case.

In this embodiment, resources in the first resource set are associated with beams in a beam set, and resources in the second resource set are associated with the beams in the beam set.

In some embodiments, the second slot offset value may be larger than the first slot offset value. In some embodiments, the first configuration information further comprises a third slot offset value associated with a third resource set for the interference measurements. This means that 1 CMR is mapped to more than 1 IMRs. In some embodiments, the third slot offset value is larger than the second slot offset value. Resources in the third resource set are associated with the beams in the beam set.

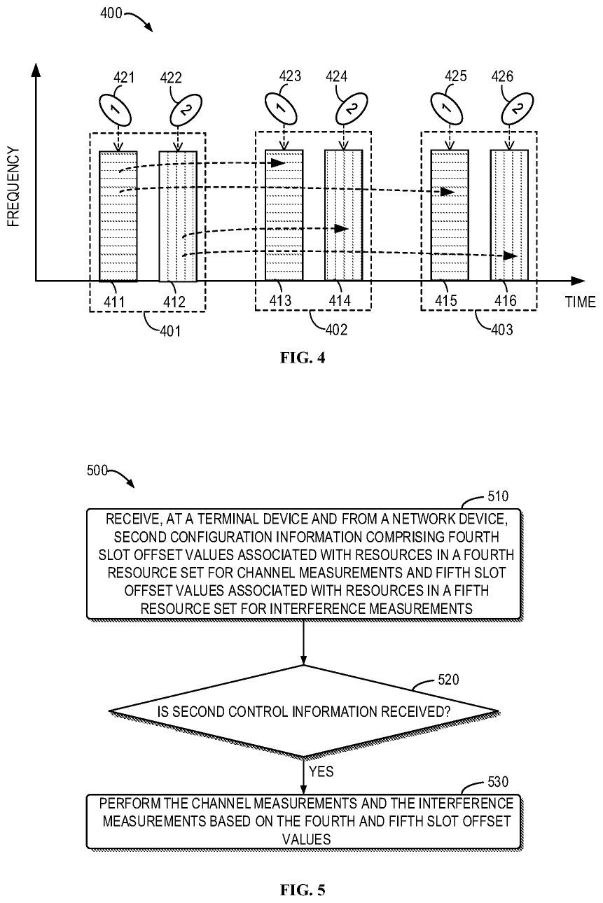

For ease of understanding, an example offset configuration in AP ZP-IMR will be further described with reference to FIG. 4. FIG. 4 shows a schematic diagram 400 illustrating resources configured for CM and IM associated with beams according to some embodiments of the present disclosure.

As shown in FIG. 4, a CSI-RS resource set 401 is configured for channel measurement, and CSI-RS resource sets 402 and 403 are configured for interference measurement. The CSI-RS resource set 401 comprises CSI-RS resources 411 and 412. Beams 421 (with an index of 1) and 422 (with an index of 2) are configured as being associated with CSI-RS resources 411 and 412. The CSI-RS resource set 402 comprises CSI-RS resources 413 and 414. The beams 423 (with an index of 1) and 424 (with an index of 2) are also configured as being associated with CSI-RS resources 413 and 414. The CSI-RS resource set 403 for IM comprises CSI-RS resources 415 and 416. Beams 425 (with an index of 1) and 426 (with an index of 2) are configured as being associated with CSI-RS resources 415 and 416 respectively.

In other words, CSI-RS resources 423 and 425 are configured to be quasi co-located with CSI-RS resource 421 with respect to ‘QCL-TypeD’, and CSI-RS resources 424 and 426 are configured to be quasi co-located with CSI-RS resource 422 with respect to ‘QCL-TypeD’. In particular, CSI-RS resources 421, 423 and 425 are associated with beam 1, and CSI-RS resources 422, 424 and 426 are associated with beam 2.

The CSI-RS resource set 401 is associated with offset 1, the CSI-RS resource set 402 is associated with offset 2, and the CSI-RS resource set 403 is associated with offset 3, where offset 3>offset 2>offset 1.

In some embodiments, the first, second and third slot offset values are used with respect to a slot in which DCI enabling the channel and interference measurements is received. In other words, AP ZP-IMR has a configurable slot offset to CMR as defined below.

CSI-IM-ResourceSet ::= SEQUENCE {
csi-IM-ResourceSetld CSI-IM-ResourceSetld,
csi-IM-Resources SEQUENCE (SIZE(1..maxNrofCSI-IM-
ResourcesPerSet))OF
CSI-IM-Resourceld,
aperiodicTriggeringOffset INTEGER(O..n) OPTIONAL, -- Need S
}

where n is the maximum slot offset used for CSI-IM resource set.

In some alternative embodiments, the second slot offset value may be determined based on the first slot offset value and a first predetermined value, and the third slot offset value may be determined based on the first slot offset value and a second predetermined value. In some embodiments, the second predetermined value may be different from first predetermined value. For example, still with reference to FIG. 4, slot offset values associated with the CSI-RS resource sets 401-403 may have the following relationship: offset 2=offset 1+K1, and offset 3=offset 1+K2, where K1 and K2 are constants and K2>K1.

In some alternative embodiments, the second slot offset value may be determined based on the first slot offset value and a predetermined value, and the third slot offset value may be determined based on the second slot offset value and the predetermined value. For example, still with reference to FIG. 4, slot offset values associated with the CSI-RS resource sets 401-403 may have the following relationship: offset 2=offset 1+K, and offset 3=offset 2+K, where K is a constant.

In these alternative embodiments, AP ZP-IMR may have a fixed slot offset to CMR as defined below.

aperiodicTriggeringOffset for CSI-IM-ResourceSet=aperiodicTriggeringOffset for CSI-IM-ResourceSet or NZP-CSI-CS-ResourceSet+Ki, where Ki is a fixed value determined by the ith set order of IMR. Ki is relative to the last symbol of CMR CSI-RS or previous set of IMR.

### Embodiment 2

In this embodiment, reference signals with an explicit transmit power are aperiodically transmitted from the network device 110 on both the first and second resource sets. This is also called as aperiodic non-zero-power interference measurement (AP NZP-IMR) case.

In this embodiment, resources in the first resource set are associated with beams in a beam set, and resources in the second resource set are associated with the beams in the beam set. The first and second resource sets can be configured as the same resource set identification. In other words, only one resource set is configured for L1-SINR beam measurement, and the resource set is configured with multiple slot offsets. By using the different slot offsets, the resource set is transmitted on different time occasions, each served as either CMR or IMR. In this case, the resource set for CM is resource-wisely quasi co-located with the resource set(s) for IM.

In some embodiments, the second slot offset value is larger than the first slot offset value. In some embodiments, the first configuration information further comprises a third slot offset value associated with a third resource set for the interference measurements, and the third slot offset value is larger than the second slot offset value. In this case, the first, second and third slot offset values are used with respect to the slot in which DCI enabling the channel and interference measurements is received.

Still with reference to FIG. 4, in this embodiment, CSI-RS resource sets 401-403 are the same resource set, and slot offset values associated with the CSI-RS resource sets 401-403 have the following relationship: offset 3>offset 2>offset 1.

In this case, IMR's offsets and CMR's offset are set-wisely independent. For example, aperiodicTriggeringOffset in IMR2>aperiodicTriggeringOffset in IMR1>aperiodicTriggeringOffset in CMR. Further, a trigger of AP NZP-CSI set can be with multiple offset values. A repetition can be set. The first offset value is for CMR, the second offset value is for IMR1, the third offset value is for IMR2, and so on.

The configurations of the first and second offset values have been described above. Returning to FIG. 3, at block 320, the terminal device 120 determines whether first control information is received. The first control information indicates that the first configuration information is used. In some embodiments, the first control information may be carried in DCI. It should be note that the first control information may be carried in any other suitable way. If the first control information is received, at block 330, the terminal device 120 perform the channel measurements and the interference measurements based on the first and second slot offset values. These measurements can be implemented with reference to FIG. 2, and is not detailed here.

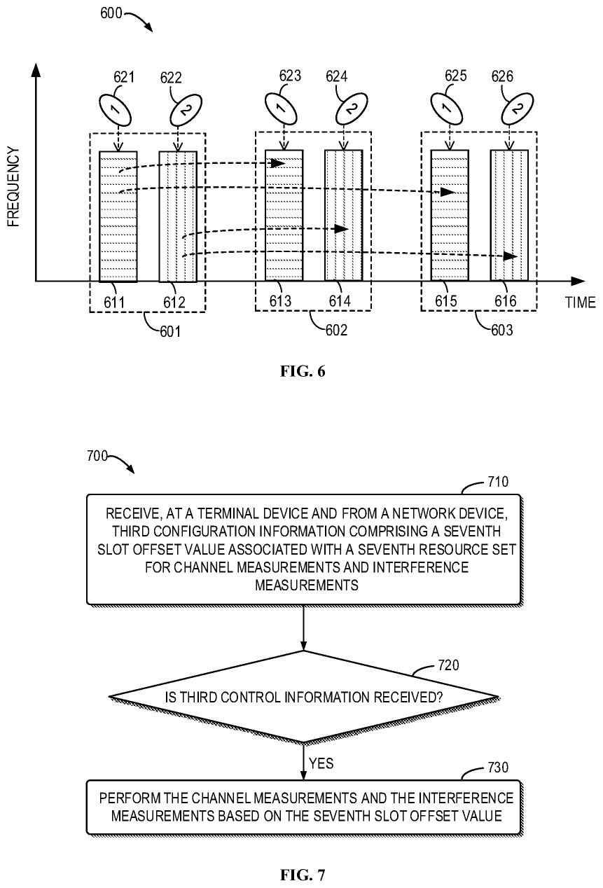

In the embodiments described above with reference to FIGS. 3 and 4, the offset values for CMR and IMR(s) are set-wisely independent. Alternatively or additionally, the offset values for CMR and IMR(s) can be resource-wisely independent. This will be detailed with reference to FIGS. 5 and 6.

FIG. 5 illustrates a flowchart of an example method 500 in accordance with some embodiments of the present disclosure. The method 500 can be implemented at the terminal device 120 shown in FIG. 1. It is to be understood that the method 500 may include additional blocks not shown and/or may omit some blocks as shown, and the scope of the present disclosure is not limited in this regard. For the purpose of discussion, the method 500 will be described with reference to FIG. 1.

At block 510, the terminal device 120 receives, from the network device 110, second configuration information comprising fourth slot offset values associated with resources in a fourth resource set for channel measurements and fifth slot offset values associated with resources in a fifth resource set for interference measurements. This will be detailed with reference to Embodiment 3.

### Embodiment 3

In this embodiment, reference signals are periodically or semi-persistently transmitted from the network device 110 on both the fourth and fifth resource sets. This is also called as P/SP NZP-IMR case.

In this embodiment, the fourth and fifth resource sets are the same resource set. Resources in the fourth resource set are associated with beams in a beam set, and resources in the fifth resource set are associated with the beams in the beam set. The fifth slot offset value associated with a first beam in the beam set is larger than the fourth slot offset value associated with the first beam.

In some embodiments, the second configuration information further comprises sixth slot offset values associated with resources in a sixth resource set for the interference measurements, resources in the sixth resource set being associated with the beams in the beam set. The sixth slot offset value associated with the first beam in the beam set is larger than the fifth slot offset value associated with the first beam.

For ease of understanding, an example offset configuration in P/SP NZP-IMR will be further described with reference to FIG. 6. FIG. 6 shows a schematic diagram 600 illustrating resources configured for CM and IM associated with beams according to some embodiments of the present disclosure.

As shown in FIG. 6, a CSI-RS resource set 601 is configured for channel measurement, and CSI-RS resource sets 602 and 603 are configured for interference measurement. The CSI-RS resource set 601 comprises CSI-RS resources 611 and 612. Beams 621 (with an index of 1) and 622 (with an index of 2) are configured as being associated with CSI-RS resources 611 and 612. The CSI-RS resource set 602 comprises CSI-RS resources 613 and 614. The beams 623 (with an index of 1) and 624 (with an index of 2) are also configured as being associated with CSI-RS resources 613 and 614. The CSI-RS resource set 603 for IM comprises CSI-RS resources 615 and 616. Beams 625 (with an index of 1) and 626 (with an index of 2) are configured as being associated with CSI-RS resources 615 and 616 respectively.

In other words, CSI-RS resources 623 and 625 are configured to be quasi co-located with CSI-RS resource 621 with respect to ‘QCL-TypeD’, and CSI-RS resources 624 and 626 are configured to be quasi co-located with CSI-RS resource 622 with respect to ‘QCL-TypeD’. In particular, CSI-RS resources 621, 623 and 625 are associated with beam 1, and CSI-RS resources 622, 624 and 626 are associated with beam 2.

Resource 611 is associated with offset 4, resource 612 is associated with offset 4′, resource 613 is associated with offset 5, resource 614 is associated with offset 5′, resource 615 is associated with offset 6, and resource 616 is associated with offset 6′, where offset 6>offset 5>offset 4, and offset 6′>offset 5′>offset 4′.

In other words, IMR's offsets and CMR's offsets are CRI-resource-wisely different. For example, periodicityAndOffset for CRI1 in IMR2>periodicityAndOffset for CRI1 in IMR1>periodicityAndOffset for CRI1 in CMR. An offset of P/SP NZP-CSI-RS can be associated with multiple offset values. A repetition can be set. The first offset value is for CMR, the second offset value is for IMR1, the third offset value is for IMR2, and so on.

The configurations of the fourth and fifth offset values have been described above. Returning to FIG. 5, at block 520, the terminal device 120 determines whether second control information is received. The second control information indicates that the second configuration information is used. In some embodiments, the second control information may be carried in DCI. It should be note that the second control information may be carried in any other suitable way. If the second control information is received, at block 530, the terminal device 120 perform the channel measurements and the interference measurements based on the fourth and fifth slot offset values. These measurements can be implemented with reference to FIG. 2, and is not detailed here.

In the embodiments described above with reference to FIGS. 3-6, the offset configurations are designed for the case that separate resource sets are configured for CMR and IMR(s). Alternatively or additionally, the offset configurations can be designed for the case that one resource set is configured for both CMR and IMR(s). This will be detailed with reference to FIGS. 7-11.

FIG. 7 illustrates a flowchart of an example method 700 in accordance with some embodiments of the present disclosure. The method 700 can be implemented at the terminal device 120 shown in FIG. 1. It is to be understood that the method 700 may include additional blocks not shown and/or may omit some blocks as shown, and the scope of the present disclosure is not limited in this regard. For the purpose of discussion, the method 700 will be described with reference to FIG. 1.

At block 710, the terminal device 120 receives, from the network device 110, third configuration information comprising seventh slot offset value associated with a seventh resource set for channel measurements and interference measurements. This will be detailed with reference to Embodiment 4.

### Embodiment 4

In this embodiment, reference signals are aperiodically transmitted from the network device 110 on the seventh resource set. This is also called as AP NZP-based CMR/IMR case.

In this embodiment, resources in the seventh resource set are associated with beams in a beam set. In this embodiment, only one resource set is needed to be configured. N resources in the seventh resource set are used for CMR and x×N resources in the seventh resource set are used for IMR, where N and x are positive integers. Only one slot offset value is set-wisely configured for the one resource set. In other words, only an offset for a first RS is configured. A repetition of the RS is set within a slot.

In this embodiment, a first resource in the seventh resource set is used for the channel measurement in a first beam of the beams, and a second resource in the seventh resource set is used for the interference measurement in the first beam, the first and second resources being respectively associated with a first slot and a second slot after the first slot. A third resource in the seventh resource set is used for the channel measurement in a second beam of the beams, and a fourth resource in the seventh resource set is used for the interference measurement in the second beam, the third and fourth resources being respectively associated with an third slot and a fourth slot after the third slot. The third slot is after the second slot. The first to fourth resources are the same resource.

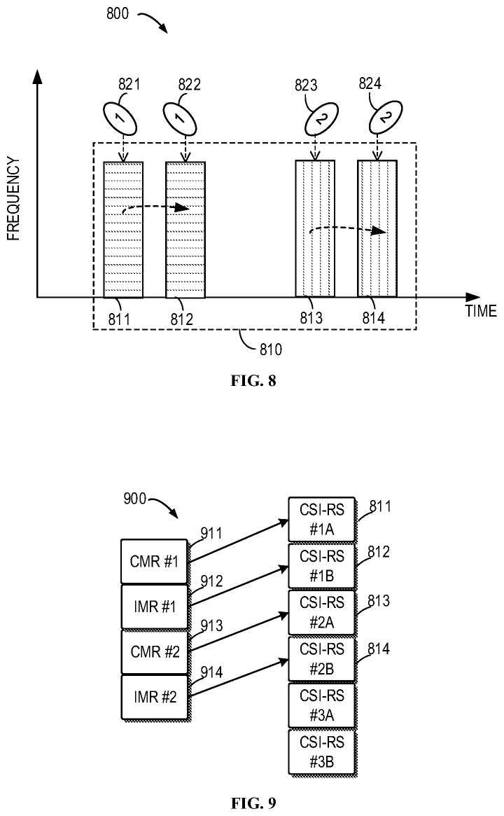

For ease of understanding, an example offset configuration in AP NZP-based CMR/IMR will be further described with reference to FIGS. 8 and 9. FIG. 8 shows a schematic diagram 800 illustrating resources configured for CM and IM associated with beams according to some embodiments of the present disclosure. FIG. 9 shows a schematic diagram 900 illustrating a correspondence relationship between CMRs and IMRs according to these embodiments.

FIG. 8 shows a CSI-RS resource set 810, which comprises CSI-RS resources 811-814. A first subset A of the CSI-RS resources 811-814 is configured for channel measurement. For example, as shown in FIG. 8, the CSI-RS resources 811 (with a CRI of 1A, see FIG. 9) and 813 (with a CRI of 2A, see FIG. 9) are configured for channel measurement. A second subset B of the CSI-RS resources 811-814 is configured for interference measurement. In the example shown in FIG. 8, the CSI-RS resources 812 (with a CRI of 1B, see FIG. 9) and 814 (with a CRI of 2B, see FIG. 9) are configured for interference measurement.

In these embodiments, beams associated with the CSI-RS resources 511-514 are configured by the network device. The resource for channel measurement and the corresponding resource(s) for interference measurement are associated with the same beam. As shown, beam 821 associated with the CSI-RS resource 811 and beam 822 associated with the CSI-RS resource 812 both have an index of 1. Beam 823 associated with the CSI-RS resource 813 and beam 824 associated with the CSI-RS resource 814 both have an index of 2. In other words, the CSI-RS resource 821 is configured to be quasi co-located with the CSI-RS resource 822 with respect to ‘QCL-TypeD’, and the CSI-RS resource 823 is configured to be quasi co-located with the CSI-RS resource 824 with respect to ‘QCL-TypeD’.

In these embodiments, the correspondence relationship between the CMRs (CSI-RS resources 821 and 823) and IMRs (CSI-RS resources 822 and 824) is configured and predetermined by the network device 110. As shown in FIG. 9, the CSI-RS resource 811 with a CRI of 1A is configured as the CMR 911 (CMR #1) and the CSI-RS resource 812 with a CRI of 1B is configured as the IMR 912 (IMR #1) corresponding to CMR #1; the CSI-RS resource 813 with a CRI of 2A is configured as the CMR 913 (CMR #2) and the CSI-RS resource 814 with a CRI of 2B is configured as the IMR 914 (IMR #2) corresponding to CMR #2.

Therefore, in this case, the CRI reported to the network device 110 may refer to a CSI-RS resource pair/a subset in the CSI-RS resource set. For the example shown in FIG. 8, a reported CRI of 1 may refer to the CSI-RS resources 811 and 812 and a reported CRI of 2 may refer to the CSI-RS resources 813 and 814.

In this embodiment, mapping order is as below: {(CRI1 CMR, CRI1 IMR), (CRL2 CMR, CRL2 IMR) . . . }. This results in less beam switching. Further, one RS set triggering slot offset and a CRI-pair with repeated RS are configured. For example, only an offset value for a CSI-RS resource 811.

The configuration of the seventh offset value has been described above. Returning to FIG. 7, at block 720, the terminal device 120 determines whether third control information is received. The third control information indicates that the third configuration information is used. In some embodiments, the third control information may be carried in DCI. It should be note that the third control information may be carried in any other suitable way. If the third control information is received, at block 730, the terminal device 120 performs the channel measurements and the interference measurements based on the seventh slot offset value. These measurements can be implemented with reference to FIG. 2, and is not detailed here.

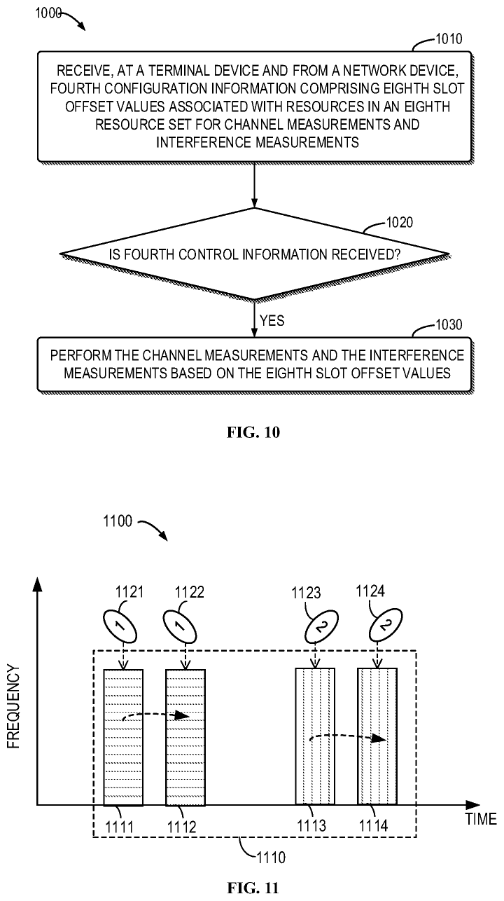

In the embodiments described above with reference to FIGS. 7-9, the offset configuration is designed for the case that the offset is set-wisely independent. Alternatively or additionally, the offset can be resource-wisely independent. This will be detailed with reference to FIGS. 10 and 11.

FIG. 10 illustrates a flowchart of an example method 1000 in accordance with some embodiments of the present disclosure. The method 1000 can be implemented at the terminal device 120 shown in FIG. 1. It is to be understood that the method 1000 may include additional blocks not shown and/or may omit some blocks as shown, and the scope of the present disclosure is not limited in this regard. For the purpose of discussion, the method 1000 will be described with reference to FIG. 1.

At block 1010, the terminal device 120 receives, from the network device 110, fourth configuration information comprising eighth slot offset values associated with resources in a eighth resource set for channel measurements and interference measurements. This will be detailed with reference to Embodiment 5.

### Embodiment 5

In this embodiment, reference signals are periodically or semi-persistently transmitted from the network device 110 on the eighth resource set. This is also called as P/SP NZP-based CMR/IMR case.

In this embodiment, resources in the eighth resource set are associated with beams in a beam set. In this embodiment, only one resource set is needed to be configured. N resources in the eighth resource set are used for CMR and x×N resources in the eighth resource set are used for IMR, where N and x are positive integers. Slot offset values are CSI-resource-wisely configured.

In this embodiment, a first resource in the eighth resource set is used for the channel measurement in a first beam of the beams, and a second resource in the eighth resource set is used for the interference measurement in the first beam, the first and second resources being respectively associated with a first slot and a second slot after the first slot. A third resource in the eighth resource set is used for the channel measurement in a second beam of the beams, and a fourth resource in the eighth resource set is used for the interference measurement in the second beam, the third and fourth resources being respectively associated with an third slot and a fourth slot after the third slot. The third slot is after the second slot. The eighth slot offset values associated with the first and second resources are both a first value, and the eighth slot offset values associated with the third and fourth resources are both a second value larger than the first value.

For ease of understanding, an example offset configuration in P/SP NZP-based CMR/IMR will be further described with reference to FIG. 11. FIG. 11 shows a schematic diagram 1100 illustrating resources configured for CM and IM associated with beams according to some embodiments of the present disclosure. FIG. 11 is similar with FIG. 8 except that offset values are respectively configured for CSI-RS resources 1111-1114. To concise, only this difference is described here and other details are not repeated.

In this embodiment, CSI-RS resources 1111 and 1112 are both configured with offset 7, and CSI-RS resources 1113 and 1114 are both configured with offset 8, where offset 8>offset 7. In other words, slot offset for CMR and IMR RS are CRI-wise equivalent.

The configurations of the eighth offset values have been described above. Returning to FIG. 10, at block 1020, the terminal device 120 determines whether fourth control information is received. The fourth control information indicates that the fourth configuration information is used. In some embodiments, the fourth control information may be carried in DCI. It should be note that the fourth control information may be carried in any other suitable way. If the fourth control information is received, at block 1030, the terminal device 120 performs the channel measurements and the interference measurements based on the eighth slot offset values. These measurements can be implemented with reference to FIG. 2, and is not detailed here.

In the embodiments described above, slot offset values for channel measurement and interference measurement are configured separately, and thus more flexible channel quality measurements associated with beams can be enabled.

It is to be understood that the resources shown in FIGS. 4, 6, 8, 9 and 11 are only for purpose of illustration and any suitable number of resources may be configured for channel and interference measurement. Although CSI-RS resource is mentioned, other types of resources suitable for channel and interference measurements may be envisaged by a person skilled in the art. Moreover, aspects descried above with respect to different embodiments may be combined.

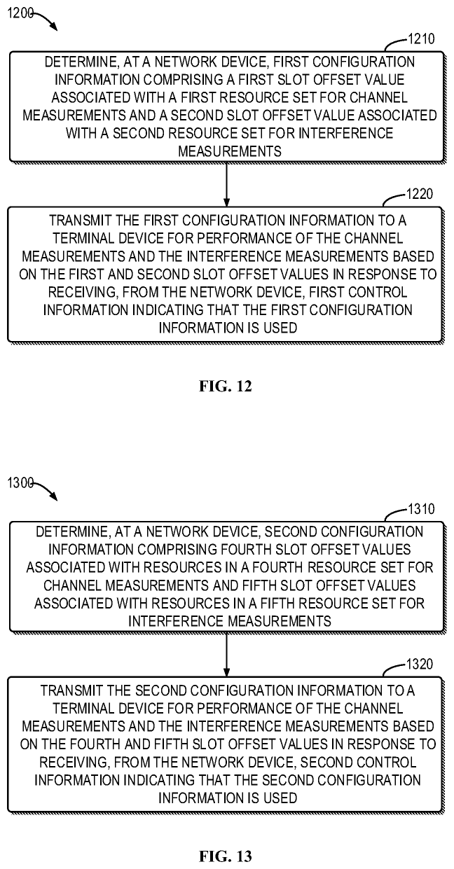

Correspondingly, embodiments of the present disclosure also provide methods implemented at a network device. This will be described with reference to FIGS. 12-15. FIG. 12 shows a flowchart of an example method 1200 in accordance with some embodiments of the present disclosure. The method 1200 can be implemented at the network device 110 shown in FIG. 1. It is to be understood that the method 1200 may include additional blocks not shown and/or may omit some blocks as shown, and the scope of the present disclosure is not limited in this regard. For the purpose of discussion, the method 1200 will be described with reference to FIG. 1.

At block 1210, the network device 110 determines first configuration information comprising a first slot offset value associated with a first resource set for channel measurements and a second slot offset value associated with a second resource set for interference measurements.

In some embodiments in which reference signals are aperiodically transmitted from the network device 110 on the first resource set and are not transmitted on the second resource set, resources in the first resource set are associated with beams in a beam set, and resources in the second resource set are associated with the beams in the beam set.

In these embodiments, the second slot offset value may be larger than the first slot offset value. In these embodiments, the first configuration information may further comprise a third slot offset value associated with a third resource set for the interference measurements, and the third slot offset value may be larger than the second slot offset value.

In some alternative embodiments, the second slot offset value may be determined based on the first slot offset value and a first predetermined value, and the third slot offset value may be determined based on the first slot offset value and a second predetermined value larger than the first predetermined value. In some alternative embodiments, the second slot offset value may be determined based on the first slot offset value and a predetermined value, and the third slot offset value may be determined based on the second slot offset value and the predetermined value.

In some embodiments in which reference signals are aperiodically transmitted from the network device 110 on both the first and second resource sets, the first and second resource sets are the same resource set. The second slot offset value is larger than the first slot offset value. The first configuration information further comprises a third slot offset value associated with a third resource set for the interference measurements, and the third slot offset value is larger than the second slot offset value. Other details are may refer to Embodiments 1 and 2.

At block 1220, the network device 110 transmits the first configuration information to the terminal device 120 for performance of the channel measurements and the interference measurements based on the first and second slot offset values in response to receiving, from the network device, first control information indicating that the first configuration information is used.

FIG. 13 shows a flowchart of an example method 1300 in accordance with some embodiments of the present disclosure. The method 1300 can be implemented at the network device 110 shown in FIG. 1. It is to be understood that the method 1300 may include additional blocks not shown and/or may omit some blocks as shown, and the scope of the present disclosure is not limited in this regard. For the purpose of discussion, the method 1300 will be described with reference to FIG. 1.

At block 1310, the network device 110 determines second configuration information comprising fourth slot offset values associated with resources in a fourth resource set for channel measurements and fifth slot offset values associated with resources in a fifth resource set for interference measurements.

In some embodiments, reference signals are periodically or semi-persistently transmitted from the network device 110 on both the fourth and fifth resource sets. In these embodiments, the fourth and fifth resource sets are the same resource set. In these embodiments, resources in the fourth resource set are associated with beams in a beam set, and resources in the fifth resource set are associated with the beams in the beam set. In these embodiments, the fifth slot offset value associated with a first beam in the beam set is larger than the fourth slot offset value associated with the first beam.

In these embodiments, the second configuration information further comprises sixth slot offset values associated with resources in a sixth resource set for the interference measurements, resources in the sixth resource set being associated with the beams in the beam set, and the sixth slot offset value associated with the first beam in the beam set is larger than the fifth slot offset value associated with the first beam. Other details are may refer to Embodiment 3.

At block 1320, the network device 110 transmits the second configuration information to the terminal device 120 for performance of the channel measurements and the interference measurements based on the fourth and fifth slot offset values in response to receiving, from the network device, second control information indicating that the second configuration information is used.

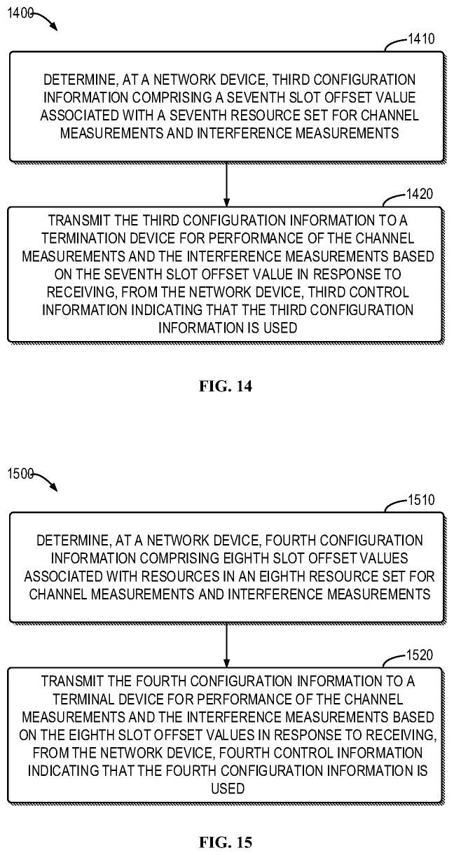

FIG. 14 shows a flowchart of an example method 1400 in accordance with some embodiments of the present disclosure. The method 1400 can be implemented at the network device 110 shown in FIG. 1. It is to be understood that the method 1400 may include additional blocks not shown and/or may omit some blocks as shown, and the scope of the present disclosure is not limited in this regard. For the purpose of discussion, the method 1400 will be described with reference to FIG. 1.

At block 1410, the network device 110 determines third configuration information comprising a seventh slot offset value associated with a seventh resource set for channel measurements and interference measurements.

In some embodiments, resources in the seventh resource set are associated with beams in a beam set, and reference signals are periodically or semi-persistently transmitted from the network device on the seventh resource set.

In these embodiments, a first resource in the seventh resource set is used for the channel measurement in a first beam of the beams, and a second resource in the seventh resource set is used for the interference measurement in the first beam, the first and second resources being respectively associated with a first slot and a second slot after the first slot. A third resource in the seventh resource set is used for the channel measurement in a second beam of the beams, and a fourth resource in the seventh resource set is used for the interference measurement in the second beam, the third and fourth resources being respectively associated with an third slot and a fourth slot after the third slot. The third slot is after the second slot, and the first to fourth resources are the same resource. Other details are may refer to Embodiment 4.

At block 1420, the network device 110 transmits the third configuration information to the terminal device 120 for performance of the channel measurements and the interference measurements based on the seventh slot offset value in response to receiving, from the network device, third control information indicating that the third configuration information is used.

FIG. 15 shows a flowchart of an example method 1500 in accordance with some embodiments of the present disclosure. The method 1500 can be implemented at the network device 110 shown in FIG. 1. It is to be understood that the method 1500 may include additional blocks not shown and/or may omit some blocks as shown, and the scope of the present disclosure is not limited in this regard. For the purpose of discussion, the method 1500 will be described with reference to FIG. 1.

At block 1510, the network device 110 determines fourth configuration information comprising eighth slot offset values associated with resources in an eighth resource set for channel measurements and interference measurements.

In some embodiments, resources in the eighth resource set are associated with beams in a beam set, and reference signals are periodically or semi-persistently transmitted from the network device 110 on the eighth resource set.

In these embodiments, a first resource in the eighth resource set is used for the channel measurement in a first beam of the beams, and a second resource in the eighth resource set is used for the interference measurement in the first beam, the first and second resources being respectively associated with a first slot and a second slot after the first slot. A third resource in the eighth resource set is used for the channel measurement in a second beam of the beams, and a fourth resource in the eighth resource set is used for the interference measurement in the second beam, the third and fourth resources being respectively associated with an third slot and a fourth slot after the third slot. The third slot is after the second slot, and the eighth slot offset values associated with the first and second resources are both a first value, and the eighth slot offset values associated with the third and fourth resources are both a second value larger than the first value. Other details are may refer to Embodiment 5.

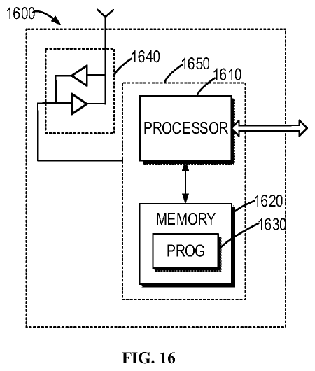

FIG. 16 is a simplified block diagram of a device 1600 that is suitable for implementing embodiments of the present disclosure. The device 1600 can be considered as a further example implementation of the network device 110 or the terminal device 120 as shown in FIG. 1. Accordingly, the device 1600 can be implemented at or as at least a part of the network device 110 or the terminal device 120.

As shown, the device 1600 includes a processor 1610, a memory 1620 coupled to the processor 1610, a suitable transmitter (TX) and receiver (RX) 1640 coupled to the processor 1610, and a communication interface coupled to the TX/RX 1640. The memory 1610 stores at least a part of a program 1630. The TX/RX 1640 is for bidirectional communications. The TX/RX 1640 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 1630 is assumed to include program instructions that, when executed by the associated processor 1610, enable the device 1600 to operate in accordance with the embodiments of the present disclosure, as discussed herein with reference to FIGS. 1 to 15.

The embodiments herein may be implemented by computer software executable by the processor 1610 of the device 1600, or by hardware, or by a combination of software and hardware. The processor 1610 may be configured to implement various embodiments of the present disclosure. Furthermore, a combination of the processor 1610 and memory 1620 may form processing means 1650 adapted to implement various embodiments of the present disclosure.

The memory 1620 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1620 is shown in the device 1600, there may be several physically distinct memory modules in the device 1600. The processor 1610 may be of any type suitable to the local technical network, and may include one or more of general purpose computers, special purpose computers, microprocessors, digital signal processors (DSPs) and processors based on multicore processor architecture, as non-limiting examples. The device 1600 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 3, 5, 7, 10 and 12-15. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A method of communication, comprising:
receiving, at a terminal device and from a network device, first configuration information comprising a first slot offset value associated with a first resource set for channel measurements and a second slot offset value associated with a second resource set for interference measurements; and
in response to receiving, from the network device, first control information indicating that the first configuration information is used, performing the channel measurements and the interference measurements based on the first and second slot offset values.

2. The method of claim 1, wherein resources in the first resource set are associated with beams in a beam set, and resources in the second resource set are associated with the beams in the beam set.

3. The method of claim 1, wherein resources in the first resource set are associated with beams in a beam set, and resources in the second resource set are associated with the beams in the beam set.

4. The method of claim 3, wherein the second slot offset value is larger than the first slot offset value.

5. The method of claim 4, wherein the first configuration information further comprises a third slot offset value associated with a third resource set for the interference measurements, and
wherein the third slot offset value is larger than the second slot offset value.

6. The method of claim 3, wherein the first configuration information further comprises a third slot offset value associated with a third resource set for the interference measurements, and
wherein the second slot offset value is determined based on the first slot offset value and a first predetermined value, and the third slot offset value is determined based on the first slot offset value and a second predetermined value larger than the first predetermined value.

7. The method of claim 3, wherein the first configuration information further comprises a third slot offset value associated with a third resource set for the interference measurements, and
wherein the second slot offset value is determined based on the first slot offset value and a predetermined value, and the third slot offset value is determined based on the second slot offset value and the predetermined value.

8. The method of claim 1, wherein reference signals are aperiodically transmitted from the network device on both the first and second resource sets, and
wherein the first and second resource sets are the same resource set.

9. The method of claim 8, wherein the second slot offset value is larger than the first slot offset value.

10. The method of claim 9, wherein the first configuration information further comprises a third slot offset value associated with a third resource set for the interference measurements, and
wherein the third slot offset value is larger than the second slot offset value.

11. A method of communication, comprising:
receiving, at a terminal device and from a network device, second configuration information comprising fourth slot offset values associated with resources in a fourth resource set for channel measurements and fifth slot offset values associated with resources in a fifth resource set for interference measurements; and
in response to receiving, from the network device, second control information indicating that the second configuration information is used, performing the channel measurements and the interference measurements based on the fourth and fifth slot offset values.

12. The method of claim 11, wherein the fourth and fifth resource sets are the same resource set,
wherein resources in the fourth resource set are associated with beams in a beam set, and resources in the fifth resource set are associated with the beams in the beam set, and
wherein reference signals are periodically or semi-persistently transmitted from the network device on both the fourth and fifth resource sets.

13. The method of claim 12, wherein the fifth slot offset value associated with a first beam in the beam set is larger than the fourth slot offset value associated with the first beam.

14. The method of claim 13, wherein the second configuration information further comprises sixth slot offset values associated with resources in a sixth resource set for the interference measurements, resources in the sixth resource set being associated with the beams in the beam set, and
wherein the sixth slot offset value associated with the first beam in the beam set is larger than the fifth slot offset value associated with the first beam.

15-24. (canceled)

25. A terminal device comprising:
configured to perform the method according to claim 1.

26. (canceled)
